(19) United States
(12) Patent Application Publication
(10) Pub. No.: US 2009/0071999 A1
(43) Pub. Date: Mar. 19, 2009

(54) GAS COMBUSTION TYPE DRIVING TOOL

(75) Inventors: Junichi Tamura, Tokyo (JP); Katsuhiko Murayama, Tokyo (JP); Hajime Takemura, Tokyo (JP); Masakazu Konishi, Tokyo (JP)

Correspondence Address: DRINKER BIDDLE & REATH (DC), 1500 K STREET, N.W., SUITE 1100, WASHINGTON, DC, 20005-1209, US

(73) Assignee: Max Co., Ltd., Tokyo (JP)

(21) Appl. No.: 12/282,262

(22) PCT Filed: Mar. 7, 2007
(86) PCT No.: PCT/JP2007/054478

§ 371 Date: Sep. 9, 2008

(30) Foreign Application Priority Data
Mar. 10, 2006 (JP) 2006-065400

(51) Int. Cl. B25C 1/14

(52) U.S. Cl. 227/10

(57) ABSTRACT

By moving a movable sleeve 10 provided above a driving cylinder 3 in a vertical direction so as to come into contact with a cylinder head 8 above the driving cylinder 3, a combustion chamber 6 becomes a closed state. When mixed gas obtained by stirring and mixing air and fuel gas by a rotary fan 21 is ignited by a spark plug 20 so as to be burned explosively in the combustion chamber 6, high-pressure combustion gas is applied to a driving piston 4 to impulsively drive the driving piston 4 so that a driver 5 coupled to a lower surface of the driving piston 4 drives a fastener. An upper wall surface on an outer portion of the combustion chamber 6 is disposed at a position far away from the spark plug 20 so that a flow speed of the mixed gas passing the upper wall surface decreases to the extent that an ignition when the mixed gas arrives at the spark plug 20 is not interrupted. An opening groove 22 is formed in the upper wall surface so as to be opened to the combustion chamber 6.

### TECHNICAL FIELD

The present invention relates to a gas combustion type driving tool which drives a fastener such as a nail by using a power generated during combustion, and more particularly, to a gas combustion type driving tool which improves a combustion chamber thereof.

### BACKGROUND ART

A gas combustion type driving tool ignites mixed gas obtained by stirring and mixing air and fuel gas by a fan to be burned explosively in a combustion chamber so that a gas pressure of combustion gas drives a driving piston (see JP-A-2001-162560).

The fuel gas and the air are supplied through an upper portion of the combustion chamber, and are stirred and mixed by the fan provided at the center of the combustion chamber.

At this time, since the mixed gas is first flown downward by the fan, the mixed gas moves downward to the bottom portion of the combustion chamber and is diffused outward. Subsequently, the mixed gas moves upward along an inner wall of the combustion chamber and arrives at a center along an upper wall of the combustion chamber. Subsequently, the mixed gas is again flown downward by the fan. In this way, the mixed gas is stirred and mixed by repeating the procedure. Since the spark plug is disposed at the upper portion of the combustion chamber, the mixed gas traverses a position in front of the spark plug while moving along the upper wall of the combustion chamber.

Although the mixed gas is ignited by the spark plug disposed in the cylinder head, it is necessary to smoothly and surely perform the ignition. In addition, it is desirable that a volume of the combustion chamber is made as large as possible.

Therefore, a structure of the combustion chamber shown in FIG. 4(a) may be supposed in which mixed gas moving along an upper wall 30 on the side of a combustion chamber 6 traverses a position just before a spark plug 20. Alternatively, a combustion structure shown in FIG. 4(b) may be supposed in which mixed gas a traverses a position far away from the spark plug 20.

In the combustion structure shown in FIG. 4(a), since the upper wall 30 of the combustion chamber 6 is high, a whole volume of the combustion chamber increases, and thus it is possible to improve combustion energy. However, since a flow of the mixed gas “a” is very adjacent to the spark plug 20, a flow speed of the mixed gas “a” passing a space in front of the spark plug 20 is fast. As a result, a problem arises in that the ignition is difficult.

In the combustion structure shown in FIG. 4(b), since a swirl occurs when a flow of the mixed gas a passes the space in front of the spark plug 20, a flow speed decreases and the ignition is more surely performed. However, since the upper wall 30 of the combustion chamber 6 is low, the whole volume of the combustion chamber becomes small. As a result, a problem arises in that combustion energy decreases.

### DISCLOSURE OF THE INVENTION

One or more embodiments of the invention provide a gas combustion type driving tool capable of easily performing an ignition by decreasing a flow speed around a spark plug and of obtaining a large volume of a combustion chamber, thereby realizing a decrease in weight and cost.

According to the one or more embodiments of the invention, in a first aspect of the invention, a gas combustion type driving tool is provided with: a driving cylinder which is disposed in a tool body; a driving piston which is provided in the driving cylinder so as to be slidable in a vertical direction; a movable sleeve which is provided above the driving cylinder; and a combustion chamber which becomes a closed state by moving the movable sleeve in the vertical direction so as to come into contact with a cylinder head above the driving cylinder, wherein when mixed gas obtained by stirring and mixing air with fuel gas by use of a fan is ignited by a spark plug disposed at the cylinder head so as to be burned explosively in the combustion chamber, high-pressure combustion gas is applied to the driving piston to impulsively drive the driving piston so that a driver coupled to a lower surface of the driving piston drives a nail, wherein an upper wall surface on an outer portion of the combustion chamber is disposed at a position far away from the spark plug so that a flow speed of the mixed gas passing the outer upper wall surface decreases to the extent that an ignition when the mixed gas arrives at the spark plug is not interrupted, and wherein an opening portion opened to the combustion chamber is formed in the upper wall surface.

In a second aspect of the invention, the opening portion may be formed in the movable sleeve.

In a third aspect of the invention, an opening surface of the opening portion may be disposed on the substantially same horizontal plane with a central lower surface of the cylinder head.

According to the first aspect of the invention, since the upper wall surface on the outer portion of the combustion chamber is disposed at a position far away from the spark plug, a flow speed of the mixed gas passing the upper wall surface decreases at a position around the spark plug, it is possible to surely perform an ignition.

Since a volume of the combustion chamber can increase as much as a volume of the opening portion, it is possible to improve fuel efficiency and thus to remarkably improve a driving force.

When the mixed gas moving along the upper wall of the combustion chamber traverses a position far away from the spark plug, the upper wall of the movable sleeve is thickened. However, since the opening portion is formed therein, it is possible to decrease weight and save material.

According to the second aspect of the invention, since a gap between the fan and the inner wall of the opening portion becomes small when the movable sleeve moves downward at the step after the combustion, it is possible to efficiently allow fresh air supplied through the upper portion of the fan to be introduced into the combustion chamber and to efficiently discharge the gas within the combustion chamber through the lower portion.

According to the third aspect of the invention, since a flow of the mixed gas is hardly disturbed by an abrupt expansion during the combustion, it is possible to efficiently use the volume of the opening portion as the volume of the combustion chamber.

Other aspects and advantages of the invention will be apparent from the following description, the drawings and the claims.

### BRIEF DESCRIPTION OF THE DRAWINGS

FIG. 1 is a longitudinal sectional diagram illustrating a main part of a gas combustion nailer in use.

FIG. 2 is a longitudinal sectional diagram illustrating a main part of the gas combustion nailer while a combustion chamber is opened.

FIG. 3(a) is a longitudinal sectional diagram illustrating a main part of the combustion chamber in which mixed gas flows.

FIG. 3(b) is a bottom diagram illustrating the main part of the combustion chamber in which the mixed gas flows.

FIG. 4(a) is a longitudinal sectional diagram illustrating a main part of a known combustion chamber in which the mixed gas flows in a state where an upper wall of the combustion chamber is high.

FIG. 4(b) is a longitudinal sectional diagram illustrating the main part of the known combustion chamber in which the mixed gas flows in a state where the upper wall of the combustion chamber is low.

### DESCRIPTION OF REFERENCE NUMERALS AND SIGNS

3: DRIVING CYLINDER
4: DRIVING PISTON
6: COMBUSTION CHAMBER
8: CYLINDER HEAD
10: MOVABLE SLEEVE
20: SPARK PLUG
21: ROTARY FAN
22: OPENING GROOVE

### BEST MODE FOR CARRYING OUT THE INVENTION

Hereinafter, an exemplary embodiment of the invention will be described.

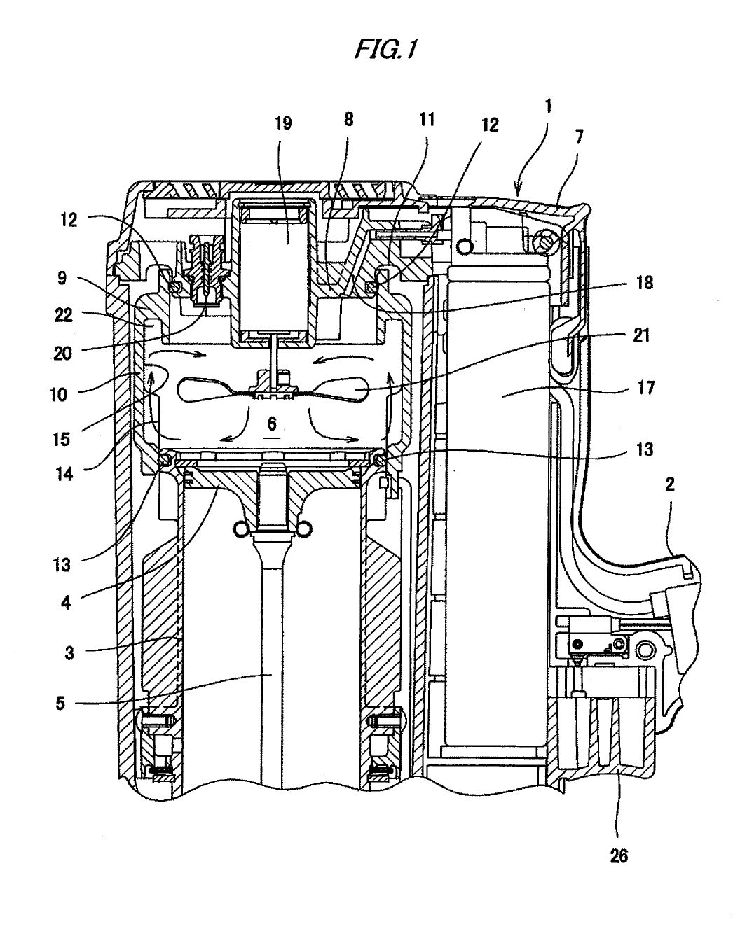

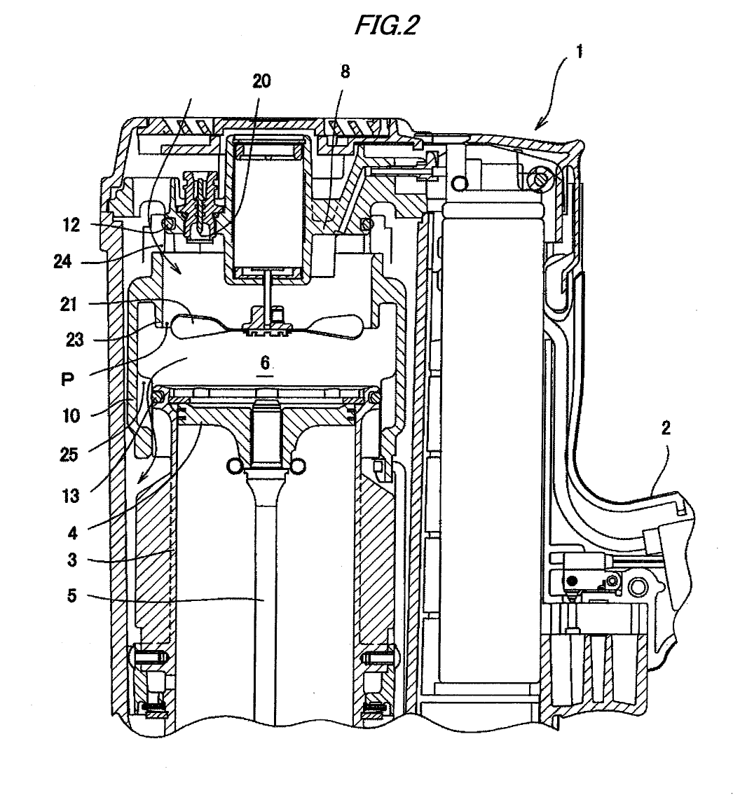

In FIGS. 1 and 2, Reference Numeral 1 denotes a tool body of a gas combustion type driving tool (nailer). The tool body 1 is sequentially connected to a grip 2 and a magazine (not shown) and has therein a driving piston/cylinder mechanism. A nose portion (not shown) is provided at the lower portion of the tool body 1 so as to drive a nail.

The driving piston/cylinder mechanism is configured such that a driving piston 4 is slidably received in a driving cylinder 3 and a driver 5 is integrally connected to the lower portion of the driving piston 4.

Next, a combustion chamber 6 is provided at the upper portion of the driving cylinder 3 so as to be opened or closed. The combustion chamber 6 is formed by the upper end surface of the driving piston 4 and a movable sleeve 10 which is disposed between the driving cylinder 3 and a cylinder head 8 formed inside an upper housing 7 so as to be movable in a vertical direction.

That is, a receiving groove 11 is formed in the bottom surface of the cylinder head 8 so as to receive the upper end of the movable sleeve 10 therein, and a seal member 12 is provided in the inner surface of the receiving groove 11. In the same way, a seal member 13 is provided in the outer surface of the upper end of the driving cylinder 3. In addition, a guide rib 14 is formed in an inner wall 15 of the movable sleeve 10 in a protruding manner from the intermediate portion to the lower end in a vertical direction.

The movable sleeve 10 is formed into a cylindrical shape and the inner wall of the upper end protrudes inward to thereby form a protruding wall 9. The inner surface of the protruding wall 9 is formed so as to come in contact with the upper seal portion 12 of the cylinder head 8. In addition, the inner surface of the lower end of the inner wall 15 of the movable sleeve 10 is disposed so as to come into contact with the lower seal portion 13 of the upper end of the driving cylinder 3.

Incidentally, the cylinder head 8 is provided with an injection nozzle 18 which communicates with a gas container 17 and a spark plug 20 which ignites and burns mixed gas. In addition, the upper housing 7 is provided with a rotary fan 21 which stirs air within the combustion chamber 6 with fuel gas injected into the combustion chamber 6 so as to generate a predetermined air/fuel ratio of mixed gas in the combustion chamber 6. Reference numeral 19 denotes a fan motor.

In the combustion chamber structure, first, when a contact arm (not shown) strongly presses a target object in order to drive the nail, the movable sleeve 10 moves upward until reaching the cylinder head 8, and the movable sleeve 10 comes into contact with the upper seal portion 12 provided at the cylinder head 8 and the lower seal portion 13 provided at the driving cylinder 3, thereby allowing the combustion chamber 6 to be in a closed state. Subsequently, the fuel gas is injected into the combustion chamber 6 through the injection nozzle 18, and the rotary fan 21 is rotated, thereby stirring and mixing the fuel gas with air. Subsequently, a trigger 26 is pulled, and the mixed gas is ignited by the spark plug 20, thereby explosively burning the mixed gas. Accordingly, the driving piston 4 is driven.

On the contrary, when the nail driving operation ends, the driving piston 4 returns to an original position, and the movable sleeve 10 moves downward as shown in FIG. 2. Subsequently, the movable sleeve 10 separates from the upper seal portion 12 and the lower seal portion 13, and the combustion chamber 6 is opened. Subsequently, fresh air is introduced from the upside, and combustion gas is discharged from the downside, thereby preparing the next nail driving operation.

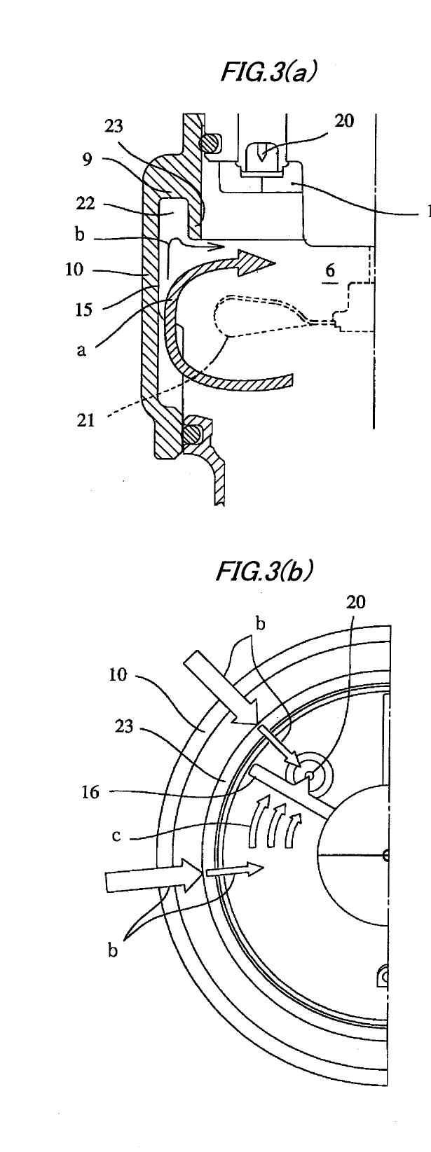

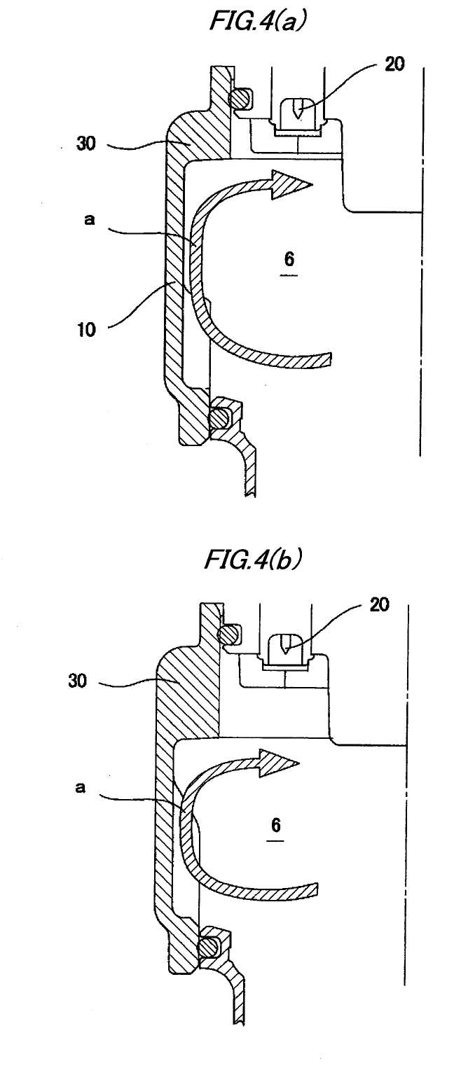

Incidentally, as specifically shown in FIGS. 3(a) and 3(b), the protruding wall 9 forming an upper wall surface on an outer portion of the combustion chamber is disposed at a position far away from the spark plug 20. That is, the protruding wall 9 has such a height that a flow speed of the mixed gas passing along the lower surface of the protruding wall 9 and reaching the spark plug 20 decreases to the extent that an ignition is not interrupted. An opening groove 22 as an opening portion is formed in the lower surface of the protruding wall 9 so as to be opened to the combustion chamber 6. Accordingly, the opening groove 22 with a ring shape is formed in the lower surface of the protruding wall 9 in the circumferential direction. Reference numeral 16 denotes a protection wall which allows a flow speed of the mixed gas mixed by the rotary fan 21 to decrease so as not to directly traverse the spark plug 20.

The outer groove wall of the opening groove 22 is flush with the inner wall 15 of the movable sleeve 10.

The upper wall surface of the combustion chamber 6 is disposed on the substantially same horizontal plane as the lower surface of the center of the cylinder head 8.

With the above-described configuration, the mixed gas is supplied into the combustion chamber 6, and is mixed with air upon rotating the rotary fan 21. At this time, since the mixed gas is first sprayed downward by the rotary fan 21, the mixed gas moves downward to the bottom portion of the combustion chamber 6 and is diffused outward. Subsequently, the mixed gas moves upward along the inner wall 15 of the combustion chamber 6 and arrives at the center along the upper wall (the lower surface of the cylinder head 8) of the combustion chamber 6. Subsequently, the mixed gas is again sprayed downward by the rotary fan 21 disposed at the center. In this way, the mixed gas is mixed by repeating the procedure. Since the spark plug 20 is disposed at the upper portion of the combustion chamber 6, the mixed gas traverses a position in front of the spark plug 20 while moving along the upper wall of the combustion chamber 6 in a direction indicated by the arrow a shown in FIGS. 1 and 3(a). In addition, a part of the mixed gas moves in a direction in which the rotary fan 21 rotates, that is, in a direction indicated by the arrow c, but a flow speed thereof decreases by the protection wall 16.

As described above, although the mixed gas traverses a position in front of the spark plug 20 when the mixed gas moves upward along the inner wall 15 of the combustion chamber 6 and moves to the center of the upper wall through the opening groove 22 of the upper wall, the mixed gas contacts with a groove wall 23 at a position just before the spark plug 20. That is, since the mixed gas moving upward along the inner wall 15 of the combustion chamber 6 enters into the opening groove 22 and takes a U-turn in a direction indicated by the arrow b so as to move downward along the inner groove wall 23 and to traverse a position in front of the spark plug 20, the groove wall 23 allows the flow speed of the mixed gas to decrease. In this way, since the flow speed of the mixed gas at a position around the spark plug 20 can decrease to the extent an ignition is not interrupted, it is possible to surely perform the ignition.

Since a volume of the combustion chamber 6 increases as much as a volume of the opening groove 22, it is possible to increase combustion energy and thus to remarkably improve a driving force.

When the mixed gas moving along the upper wall of the combustion chamber 6 traverses a position away from the spark plug 20, the upper wall of the movable sleeve 10 is thickened. However, since the opening groove 22 as a recess is formed therein, it is possible to decrease weight and save material.

In this embodiment, the opening portion is configured as the opening groove, but may be configured as a plurality of opening holes which are disposed in a ring shape.

When the mixed gas is ignited, the mixed gas is burned explosively and the driving piston 4 is driven by the gas pressure, the driving piston 4 moves downward so as to drive a nail to be driven into the target object. After the nail driving operation, since the gas within the combustion chamber 6 is cooled and becomes a negative pressure, the driving piston 4 moves upward so as to return to an initial position. When the trigger 26 is released, since the movable sleeve 10 moves downward, as shown in FIG. 2, the upper and lower ends of the movable sleeve 10 are respectively away from the seal portion 12 of the cylinder head 8 and the seal portion 13 of the upper end of the driving cylinder 3, an intake port 24 and an exhaust port 25 are respectively formed at the upper portion and the lower portion of the combustion chamber 6. Since the rotary fan 21 rotates, fresh air is introduced from the upper intake port 24 and combustion gas is discharged from the lower exhaust port 25.

Incidentally, when the movable sleeve 10 moves downward, the opening groove 22 moves downward and the inner groove wall 23 of the opening groove 22 is located at a position on the side of the rotary fan 21. For this reason, a gap p between the groove wall 23 and the rotary fan 21 is small. Accordingly, although the fresh air supplied through the intake port 24 above the rotary fan 21 is sent downward upon rotating the rotary fan 21, it is possible to efficiently introduce only the fresh air into the combustion chamber 6 in that the supplied air cannot return to the upper space through the small gap P. In the same way, it is possible to efficiently discharge the combustion gas through the exhaust port 25 because the combustion gas discharged to the lower space of the rotary fan 21 cannot return to the upper space through the gap p.

Since the volume of the combustion chamber 6 is increased as much as the volume of the opening groove 22, combustion efficiency can be improved. Accordingly, it is possible to further improve a driving force.

Since the upper wall surface of the combustion chamber 6 is disposed on the substantially same horizontal plane as the lower surface of the center of the cylinder head 8, a flow of the mixed gas is hardly disturbed by an abrupt expansion during the combustion. Accordingly, it is possible to efficiently use the volume of the opening groove 22 as the volume of the combustion chamber 6.

The gas combustion type driving tool is not limited to a nailer, but may be applied to a screw driver or the like.

While the invention has been described with reference to the specific embodiment, it should be understood, of course, that various modifications or corrections may be readily made by those skilled in the art without departing from the spirit and the scope of the invention.

This application claims the benefit of Japanese Patent application No. 2006-065400 filed on Mar. 10, 2006, the entire contents of which are incorporated herein by reference.

### INDUSTRIAL APPLICABILITY

The present invention can be applied to a gas combustion type driving tool which drives a fastener such as a nail by using a power generated during combustion.

1. A gas combustion type driving tool comprising:
a driving cylinder disposed in a tool body;
a driving piston provided in the driving cylinder so as to be slidable in a vertical direction;
a movable sleeve provided above the driving cylinder;
a combustion chamber formed by an upper end surface of the driving piston and the movable sleeve;
an upper wall surface on an outer portion of the combustion chamber; and
an opening portion formed in the upper wall surface and opened to the combustion chamber.

2. The gas combustion type driving tool according to claim 1, wherein the upper wall surface is disposed at a position far away from a spark plug so that a flow speed of mixed gas passing the upper wall surface decreases to the extent that an ignition when the mixed gas arrives at the spark plug is not interrupted.

3. The gas combustion type driving tool according to claim 1, wherein the combustion chamber is capable of being closed or opened by moving the movable sleeve in the vertical direction so as to be in contact with or separate from the driving cylinder and a cylinder head above the driving cylinder, and
wherein when mixed gas obtained by stirring and mixing air and fuel gas by a fan is ignited by a spark plug disposed in the cylinder head so as to be burned explosively in the combustion chamber, high-pressure combustion gas is applied to the driving piston to impulsively drive the driving piston so that a driver coupled to a lower surface of the driving piston drives a fastener.

4. The gas combustion type driving tool according to claim 1, wherein the opening portion is formed in the movable sleeve.

5. The gas combustion type driving tool according to claim 1, wherein an opening surface of the opening portion is disposed on the substantially same horizontal plane with a central lower surface of a cylinder head.

6. The gas combustion type driving tool according to claim 1, wherein the opening portion is formed by an inner wall of the movable sleeve and a groove wall provided in the movable sleeve.
